(19) United States
(12) Patent Application Publication
(10) Pub. No.: US 2003/0217455 A1
(43) Pub. Date: Nov. 27, 2003

(54) Stator bar handler and method

(76) Inventors: Stuart A. Oliver, Bourg, LA (US); Gary L. Stewart, Monroeville, PA (US); John D. King, Columbiana, AL (US); Terry Bergeron, Houma, LA (US); Herbert Dupre JR., Houma, LA (US); Eddie Mcmillis JR., Bourg, LA (US); Carrol J. Boyne JR., Gibson, LA (US); James L. Roberts, Cumming, GA (US); Glenn B. Ferguson, Houma, LA (US); Farrell Gillaspie, Bourg, LA (US); Harold P. Leboeuf, Houma, LA (US)

Correspondence Address: Philip D. Freedman PC, 6000 Wescott Hills Way, Alexandria, VA, 22314-4747, US

(21) Appl. No.: 10/151,975

(22) Filed: May 22, 2002

(51) Int. Cl. H02K 15/14; B23P 19/00

(52) U.S. Cl. 29/596; 29/732

(57) ABSTRACT

A flexible bar handler comprises a mobile carriage; a lift boom comprising a longitudinal shaft rotatably attached to rotate around a vertical axis of the carriage to swing an end of the shaft back and forth and pivotally attached to pivot around a horizontal axis of the carriage to raise and lower the end of the shaft; and a lift bracket comprising an elongated rail with receptor-shaped cross section to lengthwise accommodate a bar, the lift bracket being attached at a point on its length at a terminal end of the longitudinal shaft opposed to a counter weight attached at an opposite terminal end of the shaft, wherein the lift bracket is pivotally attached to a horizontal pin at the point to permit the lift bracket to tilt to one side or the other so as to raise and lower the lift bracket ends. A method of handling a stator bar; comprises loading the bar into a lift bracket comprising an elongated rail with receptor-shaped cross section, wherein the lift bracket is part of a flexible bar handler; transporting the bar to an unloading area in proximity to a stator slot of a stator core; manipulating the lift bracket by (i) swinging an end of the shaft back and forth, (ii) raising or lowering an end of the shaft, (iii) tilting the lift bracket to tilt the bracket to one side or the other so as to raise and lower the lift bracket ends or (iv) moving the bar forward or backward to position the bar for unloading into the stator slot; and unloading the bar into the slot.

### BACKGROUND OF THE INVENTION

The invention relates to a handler device for transporting a stator bar from its stator core slot to a repair area and for positioning the bar at the slot after repair and to a method to transport and position the bar.

Certain electrical devices for example power generators, have fluid cooled stator bars. Stator bars comprise insulated copper strands that are assembled in slots and brazed into copper clips on the ends to form bar assemblies. Each stator bar includes a combination of solid and hollow copper conductors, referred to as strands. The hollow strands provide a means for circulating coolant through the strand package to prevent a turbine generator from overheating and to increase the output of the generator by removing heat from the insulated bars.

The stator bars must be periodically maintained or repaired, for example to fix leaks. Repair of a leaking stator bar can require complete removal and fixing or replacement. If the bar is removed for repair, it is manually carried from its slot in the stator core to a repair area and carried back to the core when the repair is completed. If replaced, the heavy and unwieldy bar must be transported from a staging area for insertion into a slot within the stator core. Once the bar is inside the core, it is manually lifted and lowered to a correct slot and then inserted and wedged. Manually moving the unwieldy and heavy bars requires manpower and time and involves a safety hazard. There is a need to improve the method of transporting and manipulating a stator bar to position it to a correct slot so that the bar can be inserted and wedged into position.

### BRIEF DESCRIPTION OF THE INVENTION

The present invention relates to a device for improving the transportation and manipulation of a stator bar particularly during a liquid cooled stator rewind procedure. The invention provides a flexible bar handler that comprises a mobile carriage; a lift boom comprising a longitudinal shaft rotatably attached to rotate around a vertical axis of the carriage to swing an end of the shaft back and forth and pivotally attached to pivot around a horizontal axis of the carriage to raise and lower the end of the shaft; and a lift bracket comprising an elongated rail with receptor-shaped cross section to lengthwise accommodate a bar, the lift bracket being attached at a point on its length at a terminal end of the longitudinal shaft opposed to a counter weight attached at an opposite terminal end of the shaft, wherein the lift bracket is pivotally attached to a horizontal pin at the point to permit the lift bracket to tilt to one side or the other so as to raise and lower the lift bracket ends.

A method of handling a stator bar; comprises loading the bar into a lift bracket comprising an elongated rail with receptor-shaped cross section, wherein the lift bracket is part of a flexible bar handler that comprises:

a lift boom comprising a longitudinal shaft rotatably attached to rotate around a vertical axis of the carriage to swing an end of the shaft back and forth and pivotally attached to pivot around a horizontal axis of the carriage to raise and lower the end of the shaft; and

the lift bracket being attached at a point on its length at a terminal end of the longitudinal shaft opposed to a counter weight attached at an opposite terminal end of the shaft, wherein the lift bracket is pivotally attached to a horizontal pin at the point to permit the lift bracket to tilt to one side or the other so as to raise and lower the lift bracket ends;

transporting the bar to an unloading area in proximity to a stator slot of a stator core; manipulating the lift bracket by (i) swinging an end of the shaft back and forth, (ii) raising or lowering end of the shaft, (iii) tilting the lift bracket to tilt the bracket to one side of the other so as to raise and lower the lift bracket ends or (iv) a forward or backward movement to position the bar for unloading into the stator slot; and unloading the bar into the slot.

### BRIEF DESCRIPTION OF THE DRAWINGS

FIG. 1 is a side elevation view of the articulated stator bar handler;

FIG. 2 is a front elevation view of the handler showing the extent of the boom assembly;

FIG. 3 is a front elevation view of the carriage shown in FIG. 1;

FIG. 4 is a side elevation view of the carriage shown in FIG. 1;

FIG. 5 is a detail of the area designated A in FIG. 4.; and

FIG. 6 is a side elevation view of s joint structure shown in FIGS. 1 and 2.

### DETAILED DESCRIPTION OF THE INVENTION

The invention is an articulated mechanical device that that can be used to transport a stator bar into a core from a repair deck and positions it to a correct slot. The bar handler is designed with raising/lowering, projecting/retracting, tilting or transporting functionalities to facilitate manipulation of a bar, particularly a stator bar from a staging area to insert into a stator core bar slot. The bar is inserted into the slot and wedged into position. The device provides support for accurate positioning of the bar in relation to the slot and the end positions prior to insertion.

The device and method eliminate the physical stress involved in manually lifting, carrying and positioning a bar and at the same time reduce the total man-hours to manipulate the bar by 50 percent. The invention substantially reduces average cycle time for a liquid cooled stator rewind by as much as from 42 days to 22 days for 4 pole stators. The device and method reduce insulation damage to the bar by positioning laterally the bar at a core slot position prior to insertion to eliminate sliding the bar from bar slot end to end. The device and method are of particular advantage in the nuclear industry to reduce liquid cooled stator rewind cycle times, maintain quality and to provide short outage cycles. In one test, 10 technicians were used to transport and nest a 325 lb. stator bar into a mock 4 pole stator bore while the invention permitted installing the bar by two technicians.

The invention provides a flexible bar handler that is functionalized to lengthwise cradle a longitudinal bar, for example a stator bar, to raise and lower the bar, to tip the bar so that each end of the bar is raised or lowered, to generally move forward and backward to bring the bar into proximity of an insertion location such as a generator and to telescope the bar both forward and backward to manipulate the bar within tight quarters, for example into proximity of a stator bar slot. These features and further features of the invention will become apparent from the drawings and following detailed discussion, which by way of example without limitation describe preferred embodiments of the present invention.

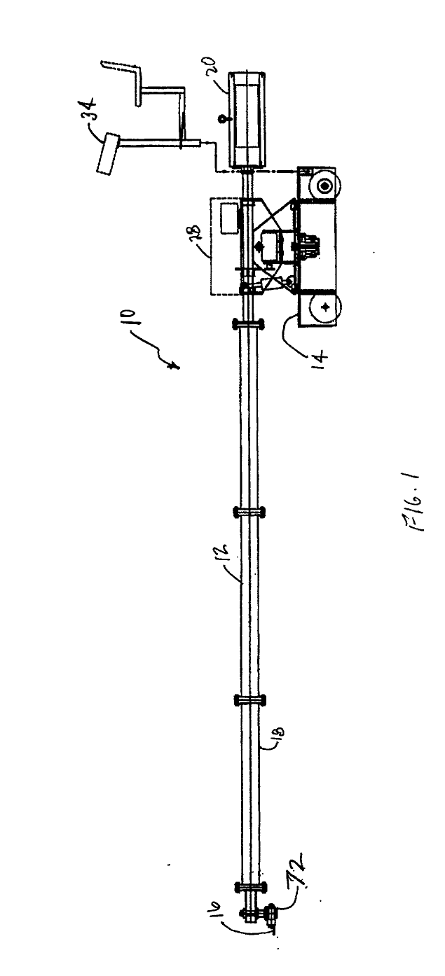

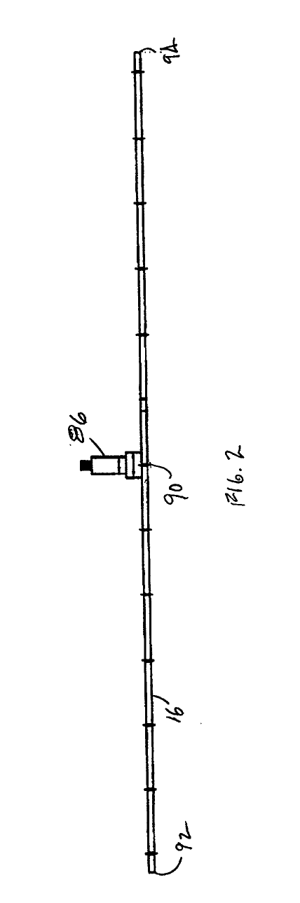

FIGS. 1 and 2 show an articulated stator bar handler 10 comprising boom assembly 12, carriage 14 and lift bracket 16. The boom assembly 12 includes an elongated shaft 18 with counter weight 20 and lift bracket 16 situated at opposing ends. The boom shaft 18 is operatively mounted on carriage 14 to be hydraulically powered as hereinafter described.

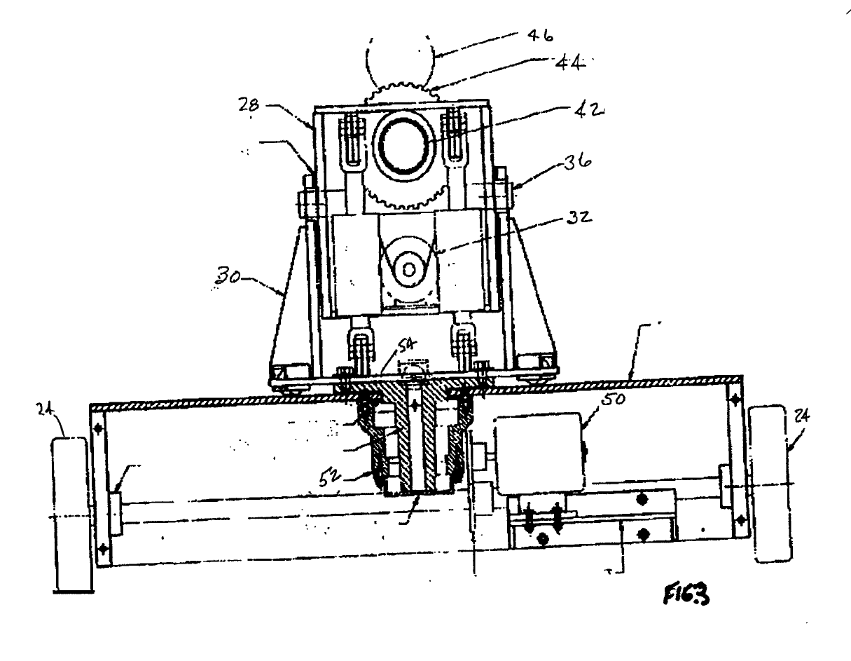

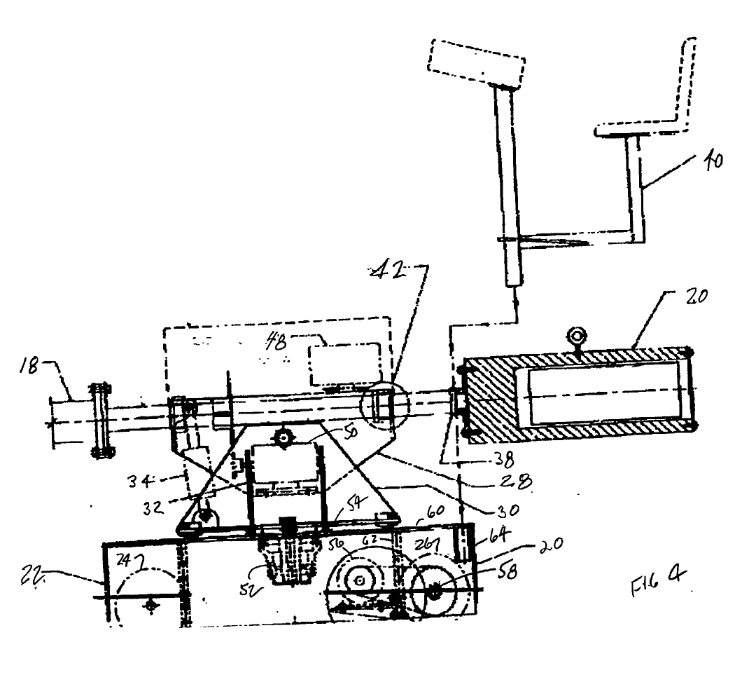

FIGS. 3 and 4 are detail drawings of the carriage 14. With reference to these FIGS., carriage 14 includes rear end plate 21 and front end plate 22, front wheels 24 and rear wheels 26, upper swivel unit 28 and lower swivel unit 30. Electric motor 32 drives ram 34 that connects to the boom shaft so that the shaft 18 can be raised and lowered through horizontal pivot pin 36. Activation of the ram 34 to drive the shaft 18 correspondingly raises and lowers the lift bracket 16 secured to the end of the shaft 18. Counterweight 20 is secured to the opposing end of the shaft 18 via boom shaft end flange 38.

Seat control and panel assembly 40 is operatively connected to the boom assembly 12 at carriage 14.

Upper swivel unit 28 of carriage 14 encloses a boom shaft bushing 42 that supports supporting boom shaft sprocket 44 and hydraulic pump 46 driven by hydraulic motor 48. Lower swivel unit 30 encloses electric motor 32 that drives swivel base assembly 52 to orient turntable 54. The combination of electric motor 32, swivel base assembly 52 and turntable 54 provide a horizontal rotating functionality to the carriage 14 to permit horizontal orienting of the boom shaft 18 to correspondingly permit horizontal orienting of the lift bracket 16 at the opposing end of the shaft 18.

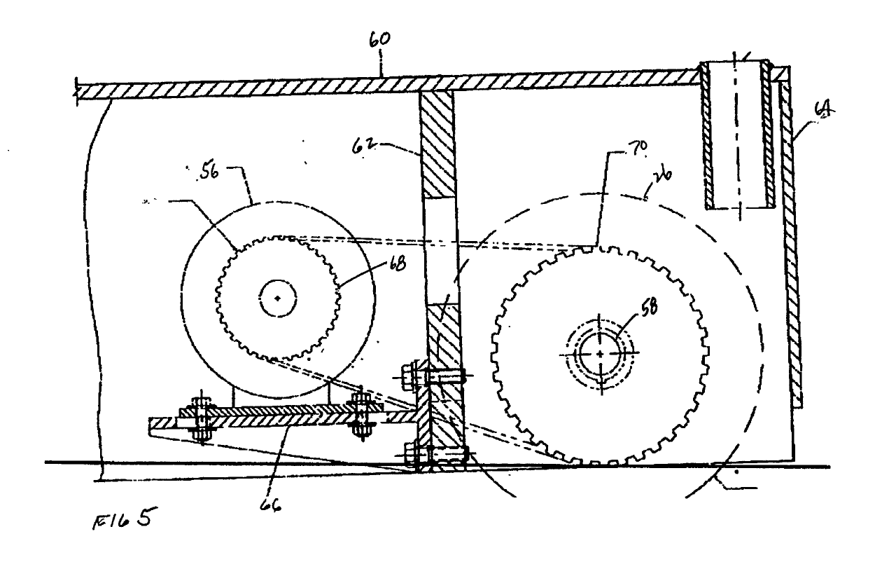

FIG. 5 is a detail of the area designated A in FIG. 4. Cover plate 60, base cross plate 62 and front to rear base plate 64 define and support a base for carriage 14 that encloses electric motor 56 mounted on motor mounting bracket 66. The motor 56 rotates motor sprocket 68 to drive wheel sprocket 70 of wheel axle 58 to power the wheels 26 so that the carriage is mobile for moving to a bar loading location and to transport a bar from one location to another.

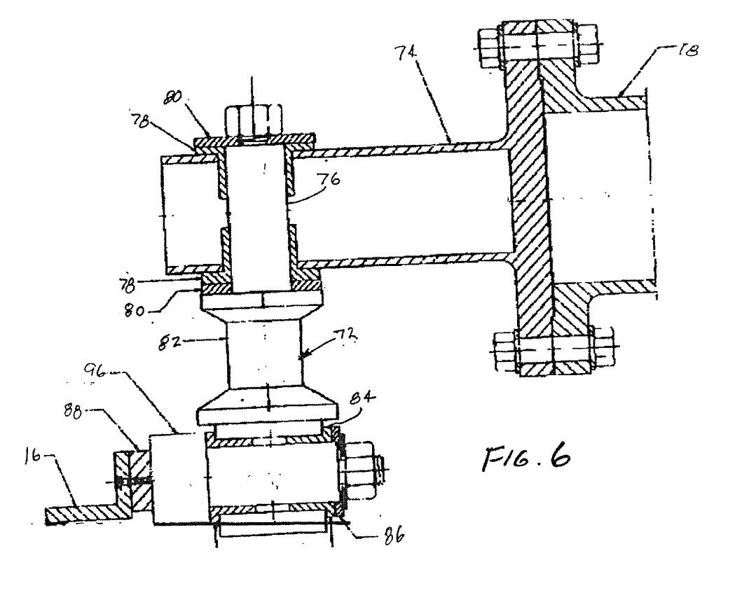

Lift bracket 16 is connected to boom shaft 18 by joint structure 72 shown in FIGS. 1 and 2. FIG. 6 is detail of the joint structure 72 showing the manner of connection of lift bracket 16 to boom shaft 18. In reference to FIG. 6, shown is shaft extension 74 accommodating a vertical pin 76 that is pivotally secured through the body of the shaft extension 74 by nylon bushings 78 and brass fastener 80. Vertical channel 82 encompasses a lower portion of the vertical pin 76, separating the pin 76 from horizontal channel 84. Horizontal channel 84 accommodates horizontal pin 86 secured within the channel 84 via adapter 96 to steel flat bar 88 and lift bracket 16, which in this embodiment is a strip of aluminum angle. The vertical pin 82 provides a horizontal swinging functionality to the handler 10 that permits the lift bracket 16 to be rotated horizontally, back and forth. This functionality and the horizontal rotating functionality imparted at the carriage 14 provide combined gross and fine horizontal positioning functionalities that permit positioning in close quarters such as in the core of a turbine generator. As shown in FIG. 2, the lift bracket 16 is secured to the joint structure 72 at a point 90 along its longitudinal axis. Hence, the horizontal pin 86 connecting the lift bracket 16 at this point 90 imparts a vertical swinging functionality to the handler 10 that permits the lift bracket 16 to tilt to one side or the other so as to raise and lower the lift bracket ends 92, 94.

In operation, a stator bar can be longitudinally loaded into the handler lift bracket 16 comprising an elongated rail with receptor-shaped cross section secured into the receptor by bar straps, cinches or fittings (not shown) of the lift bracket 16. Typically in operation, the handler 10 is loaded with a bar at a repair staging area. The lift bracket 16 is positioned to accept the bar by positioning by means of one of the raising/lowering, projecting/retracting, tilting or transporting functionalities of the handler 10. The bar is then transported to a unloading area typically in proximity to a stator slot of a stator core. The bar is manipulated into position for insertion into the slot by manipulating the lift bracket 16 by (i) swinging an end of the boom shaft 18 back and forth, (ii) raising or lowering end of the shaft 18, (iii) tilting the lift bracket 16 to tilt the bracket to one side of the other so as to raise and lower the lift bracket ends 92, 94 or (iv) a forward or backward movement to position the bar for unloading into the stator slot. When the bar is positioned for easy insertion into the slot, any securing feature is unattached and the bar is loaded manually or otherwise into the slot.

While preferred embodiments of the invention have been described, the present invention is capable of variation and modification and therefore should not be limited to the precise details of the Examples. The invention includes changes and alterations that fall within the purview of the following claims.

What is claimed is:

1. A flexible bar handler, comprising:
a mobile carriage;
a lift boom comprising a longitudinal shaft rotatably attached to rotate around a vertical axis of the carriage to swing an end of the shaft back and forth and pivotally attached to pivot around a horizontal axis of the carriage to raise and lower the end of the shaft; and
a lift bracket comprising an elongated rail with receptor-shaped cross section to lengthwise accommodate a bar, the lift bracket being attached at a point on its length at a terminal end of the longitudinal shaft opposed to a counter weight attached at an opposite terminal end of the shaft, wherein the lift bracket is pivotally attached to a horizontal pin at the point to permit the lift bracket to tilt to one side or the other so as to raise and lower the lift bracket ends.

2. The handler of claim 1, wherein the lift bracket is pivotally attached to a vertical pin at the point to permit the lift bracket to rotate horizontally.

3. The handler of claim 1, wherein the lift bracket to attached at the terminal end of the shaft by a shaft extension that is fitted to extend from within the shaft so as to telescopically retract into and extend from within the shaft.

4. A method of handling a stator bar; comprising:
loading the bar into a lift bracket comprising an elongated rail with receptor-shaped cross section, wherein the lift bracket is part of a flexible bar handler that comprises:
a lift boom comprising a longitudinal shaft rotatably attached to rotate around a vertical axis of the carriage to swing an end of the shaft back and forth and pivotally attached to pivot around a horizontal axis of the carriage to raise and lower the end of the shaft; and
the lift bracket being attached at a point on its length at a terminal end of the longitudinal shaft opposed to a counter weight attached at an opposite terminal end of the shaft, wherein the lift bracket is pivotally attached to a horizontal pin at the point to permit the lift bracket to tilt to one side or the other so as to raise and lower the lift bracket ends;
transporting the bar to an unloading area in proximity to a stator slot of a stator core;
manipulating the lift bracket by (i) swinging an end of the shaft back and forth, (ii) rasing or lowering an end of the shaft, (iii) tilting the lift bracket to tilt the bracket to one side or the other so as to raise and lower the lift bracket ends or (iv) moving the bar forward or backward to position the bar for unloading into the stator slot; and
unloading the bar into the slot.
